(19) United States
(12) Patent Application Publication
(10) Pub. No.: US 2017/0036946 A1
(43) Pub. Date: Feb. 9, 2017

(54) A THERMOCHROMIC GLASS MATERIAL AND A PRODUCTION METHOD THEREOF

(71) Applicant: ISTANBUL TEKNIK UNIVERSITESI, ISTANBUL (TR)

(72) Inventors: Miray CELIKBILEK ERSUNDU, Istanbul (TR); Suheyla AYDIN, Istanbul (TR); Ali Ercin ERSUNDU, Istanbul (TR)

(73) Assignee: Istanbul Teknik Universitesi, Istanbul (TR)

(21) Appl. No.: 15/305,096

(22) PCT Filed: May 6, 2015
(86) PCT No.: PCT/TR2015/000193

§ 371 Date: Oct. 18, 2016

(30) Foreign Application Priority Data
May 7, 2014 (TR) 2014/05119

(51) Int. Cl. C03C 3/12; C03B 19/09; C03C 4/02; C03C 4/14; C09K 9/00; C03C 3/23

(52) U.S. Cl. CPC C03C 3/122; C09K 9/00; C03C 3/23; C03C 4/02; C03C 4/14; C03B 19/09; C03C 2204/00

(57) ABSTRACT

The present invention relates a thermochromic glass material comprising heavy metal oxide, alkali oxide, halide and at least one of other compounds supporting glass formation together with tellurium oxide (TeO₂); and a production method thereof comprising the steps of preparing the powder mixture comprising TeO₂ (101), melting the mixture by heating (102), cooling the molten mixture by pouring into a mold and obtaining glass (103), keeping the glass removed from the mold in a drying oven and cooling (104).

### FIELD OF THE INVENTION

The present invention relates to a thermochromic glass material comprising heavy metal oxide, alkali oxide, halide and at least one of some other compounds supporting glass formation together with tellurium oxide (TeO₂) and a production method thereof.

### BACKGROUND OF THE INVENTION

Thermochromism is the reversible or irreversible change in optical properties of the material with the effect of temperature. Continuous color change observed gradually in the material depending on the changing temperature is called continuous thermochromism; whereas discontinuous thermochromism is the color change occurring in the material at a determined transition temperature as a result of a structural transition which is experienced.

Until today, there are limited number of studies concerning glasses with thermochromic properties and thermochromic property mechanism of the glasses, apart from glasses exhibiting thermochromic properties with thin film coatings made on the glass.

In studies concerning thermochromic glasses; Abe et. al. determined that phosphate glasses change color as a result of phase transition of the phosphorus present as colloidal particles in glass structure with changing temperature, and this transition exhibits reversible properties.¹ Kawashima et. al. determined the thermochromic transition temperatures of phosphate glasses.² Sen et. al. determined that Bi₂O₃ addition in borate glasses causes reversible thermochromic property since ions are highly polarized with increasing temperature and Bi₂O₃ ratio.³ Chen et. al. determined that Bi₂O₃—CdO—Al₂O₃ glasses exhibit reversible thermochromic property depending on Bi₂O₃ ratio and bonds are polarized and weaken with increased Bi₂O₃ ratio, and optical band gap narrows and the absorption edge is shifted to higher wavelengths.⁴ Chen et. al. determined that Bi₂O₃—Li₂O glasses exhibit thermochromic property, and temperature coefficient of the optical absorption edge of glasses increases with the increased Bi₂O₃ ratio.⁵ Bahgat et. al. determined that lead oxide glasses comprising WO₃ exhibit thermochromic behaviour.⁶ ¹ Abe, Y., Kawashima, K. ve Suzuki, S. Thermochromism in reduced phosphate glasses. Journal of the American Ceramic Society, 64, 206-209, 1981.² Kawashima, K, Ding, J., Hosono, H. and Abe, Y. DTA studies for thermochromism and thermal bleaching in reduced phosphate glasses. The Ceramic Society of Japan, 97, 823-827, 1989³ Sen, A., Kumar, J. ve Chakravorty, D. Thermochromism in borate glasses containing bismuth oxide. Journal of Materials Science Letters, 2, 677-679, 1983⁴ Chen, D., Miura, Y., Nanba, T. and Osaka, A. Thermochromism and temperature dependence of the energy gap in cadmium aluminum bismuthate glasses. Journal of the Ceramic Society of Japan, 104, 79-83, 1996⁵ Chen, D. P., Jiang, X. W. and Zhu, C. S. Study on the thermochromic properties of Bi₂O₃—Li₂O glasses. Acta Physica Sinica, 50, 1501-1506, 2001⁶ Bahgat, A. A., El-Samanoudy, M. M. and Sabry, A. I. Optical and electrical properties of binary WO₃—Pb₃O₄ glasses. Journal of Physics and Chemistry of Solids, 60, 1921-1931, 1999

In addition to these, Japanese Patent document no JP2735147B2, an application known in the state of the art, discloses to obtain a thermochromic material whose optical characteristics vary automatically and reversibly in accordance with the environmental temperature in vanadium dioxide film containing tungsten by a reactive binary simultaneous sputtering. Since the material causes semi-conductive metal phase transition, its infrared transmittance automatically changes with the changing temperature.

Japanese Patent document no JP08040749A, another application known in the state of the art, discloses thermochromic glass avoiding shading in color due to the deterioration of optical properties and extremely resistant to weather conditions, and the production method thereof. Furthermore, several metal oxides that can be used in the thermochromic glass are disclosed in detailed description part.

Li et. al. determined that there is a reversible shift in absorption bands of silicate, borosilicate and phosphosilicate glasses containing 80% and above PbO and TeO₂ by weight with changing temperature, and thermochromic property is caused by increased temperature and increase in Pb²⁺ and Te⁴⁺ bond polarization together with PbO and TeO₂ ratio.⁷ Inoue et. al. determined that absorption edge of TeO₂—Na₂O, TeO₂—Fe₂O₃, B₂O₃—PbO and PbO—SiO₂ glasses containing transition metal oxide is shifted towards the red wavelength in the optical spectrum with increasing temperature and these glasses exhibit reversible thermochromic property in visible region.⁸ ⁷ Li, G., Nogami, M. and Abe, Y. Temperature and compositional dependence of optical absorption edge in glasses containing PbO and TeO2. Journal of Materials Research, 9, 2319-2322, 1994⁸ Inoue, S., Shimizugawa, Y., Nukui, A. and Maeseto, T. Thermochromic property of tellurite glasses containing transition metal oxides. Journal of Non-Crystalline Solids, 189, 36-42, 1995

Even though the previous art discloses glasses containing tellurium oxide, no glass or glass production method exhibiting thermochromic property by means of tellurium oxide directly contained therein is disclosed. In thermochromic glasses containing tellurium oxide known in the technique, the said thermochromic property is provided via the semi-conductivity of transition metals, polarization ability of metal ions or bond polarization in these glasses.

### SUMMARY OF THE INVENTION

The objective of the present invention is to provide a semi-conductive thermochromic glass material.

Another objective of the present invention is to provide a reversible thermochromic glass material.

A further objective of the present invention is to provide a thermochromic glass material containing tellurium oxide.

Yet another objective of the present invention is to provide a production method for thermochromic glass material which has the abovementioned features.

### DETAILED DESCRIPTION OF THE INVENTION

The figures of the inventive thermochromic glass material and a production method thereof are as follows:

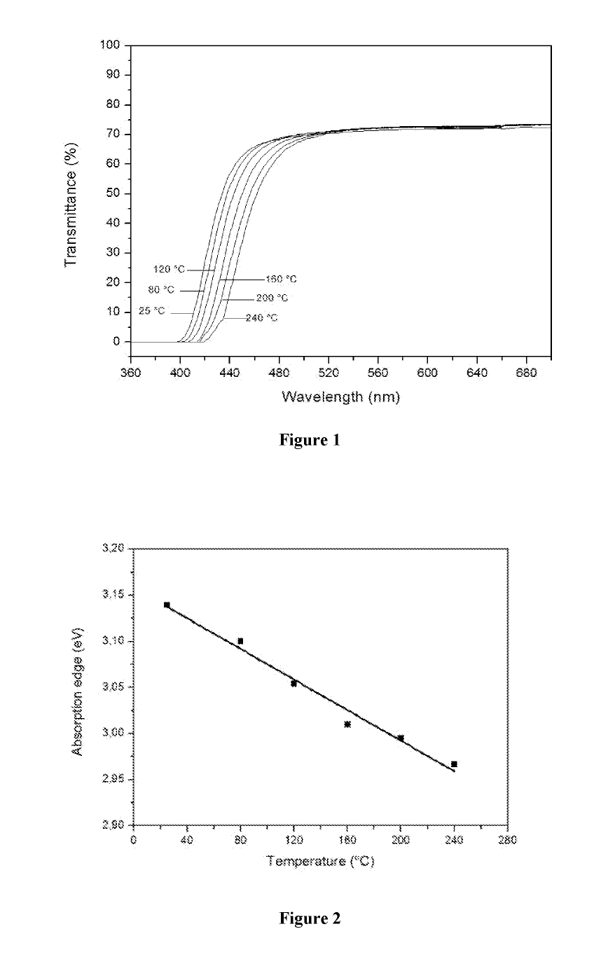

FIG. 1—The graph showing the change in transmittance values in visible region depending on temperature observed in one embodiment of the inventive glass material.

FIG. 2—The graph showing the absorption edge values changing with the increasing temperature in one embodiment of the inventive glass material.

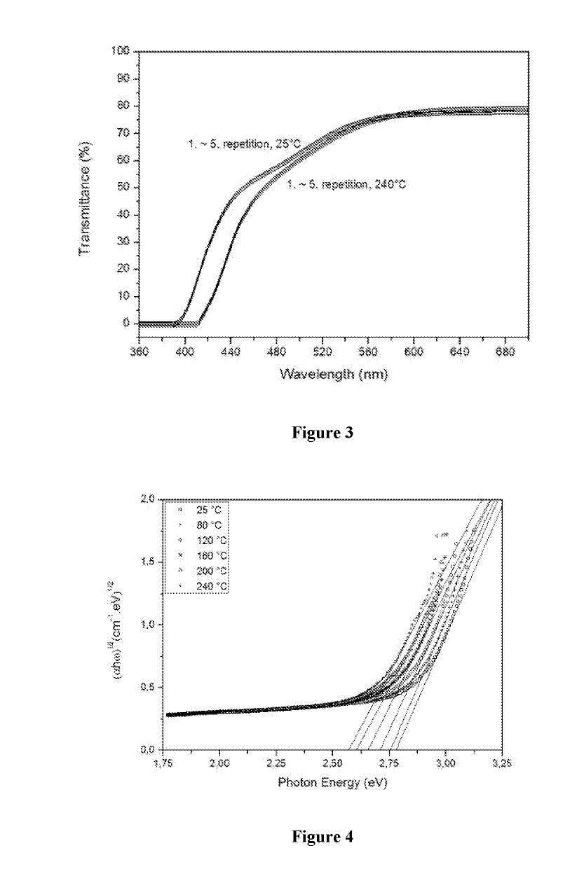

FIG. 3—The graph showing the repetitive change in transmittance values in visible region depending on temperature observed in one embodiment of the inventive glass material.

FIG. 4—The graph showing the change in optical band gap energy depending on temperature observed in one embodiment of the inventive glass material.

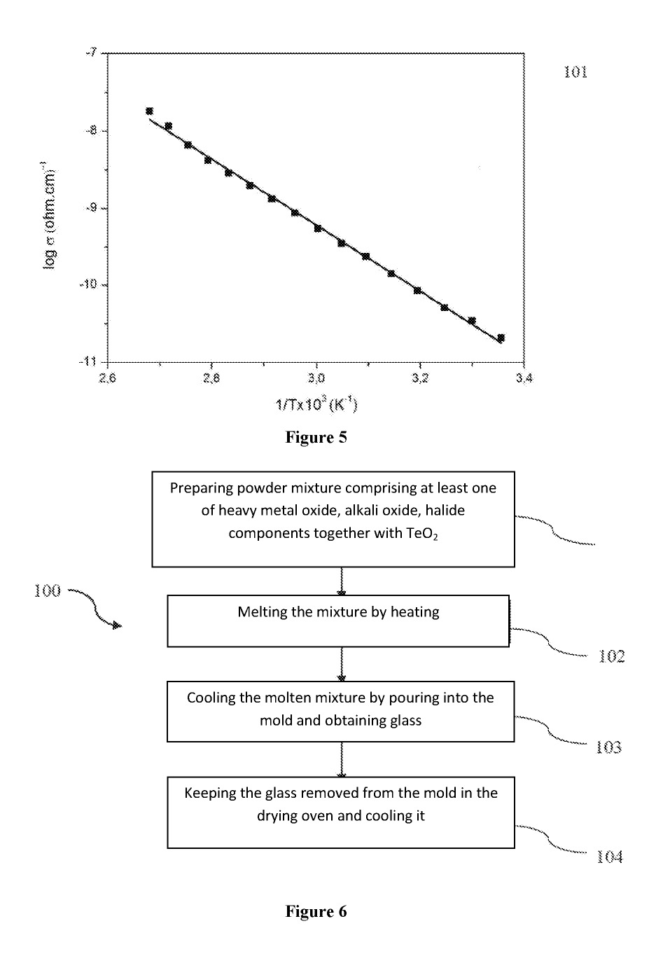

FIG. 5—The graph showing the change in conductivity values depending on temperature observed in one embodiment of the inventive glass material.

FIG. 6 is the flow chart of the inventive method.

The inventive thermochromic glass material essentially comprises at least one of heavy metal oxide, alkali oxide, halide components together with tellurium oxide (TeO₂) in order to achieve glass formation.

In the preferred embodiment of the invention, the glass material comprises at least one of WO₃, Li₂O, Na₂O, K₂O, ZnO, CdO, B₂O₃, TiO₂, CuO, Fe₂O₃, V₂O₅, PbO, Nb₂O₅, MoO₃, GeO₂, P₂O₅, Ag₂O, Sb₂O₃, PbF₂, LiCl, ZnCl₂ compounds as well as TeO₂ in ratio of 30-95% by mole, the ratios of the said compounds in the composition are 0-35%, 0-45%, 0-40%, 0-30%, 0-40%, 0-15%, 0-27.5%, 0-15%, 0-50%, 0-20%, 0-55%, 0-20%, 0-25%, 0-55%, 0-30%, 0-25%, 0-20%, 0-20%, 0-25%, 0-30%, 0-30% by mole, respectively.

The inventive glass material allows electronic passages by behaving like a conductive electrolyte. The transmittance and absorption edge values of the material in the visible region change with the temperature (FIG. 1 and FIG. 2). Therefore, the inventive glass material can continuously change its color depending on its band gap energy change with the increased temperature. Furthermore, as the applied temperature decreases, the transmittance and absorption edge values of the visible region return to the previous values and thus show reversible features. In FIG. 3 that the thermochromic property of the inventive material is reversible is shown with the graph showing the change in transmittance values as a result of heating and cooling. The thermochromic glass used in the graph given in FIG. 3 comprises 80% TeO₂, 10% WO₃, 10% Li₂O by mole.

In one embodiment of the invention, the ratios of the compounds inside the thermochromic glass are 50% TeO₂, 25% WO₃, 25% Li₂O by mole. According to this embodiment of the invention, the changes in transmittance and absorption edge values with temperature are given in FIG. 1 and FIG. 2, and the changes in optical band gap energy and observed conductivity values with temperature are given in FIG. 4 and FIG. 5.

A thermochromic glass material production method (100) developed to fulfill the objective of the present invention comprises the steps of
preparing powder mixture comprising at least one of heavy metal oxide, alkali oxide, halide together with TeO₂ (101),
melting the mixture by heating (102),
cooling the molten mixture by pouring into the mold and obtaining glass (103),
keeping the glass removed from the mold in the drying oven and cooling it (104).

In the inventive method (100), first the content of the powder mixture to be mixed is determined, and each component to be in the mixture are weighed and mixed with each other homogenously (101).

While preparing the powder mixture (101), in order to obtain Li₂O, Na₂O, K₂O and B₂O₃ components in the final product, Li₂CO₃, Na₂CO₃, K₂CO₃ and H₃BO₃ are used as starting materials. The carbonates and hydrates which are used are degraded during melting and they transform into oxide.

In the preferred embodiment of the invention, the mixture is placed into a furnace preheated to 750-900° C. within a crucible with lid manufactured from platinum or gold in order to heat and melt. It is enabled to be molten by waiting for 30-60 minutes in the determined temperature range (102).

Cooling and shaping the mixture after melting can be performed in various ways. In one embodiment of the invention, in order to prevent the molten glass mixture from suddenly cooling and cracking during pouring into a mold, first the mixture is poured into a stainless steel or bronze mold preheated to 200-250° C. (103).

The glass material poured into a mold is kept for 60-120 minutes in a drying oven heated to 200-300° C., and then it is cooled to room temperature in a controlled way (104). With controlled and slow cooling performed in this way, internal stresses are eliminated.

The change in optical features of the obtained glass samples in thickness of 1-3 mm in the visible region was measured with a UV-Vis spectrophotometer having an in-situ heating unit. Measurements were performed for temperatures selected between the room temperature and glass transition temperature. The changes in the visible region spectra obtained depending on temperature are determined in %, transmittance or absorption; the optical band gap energy values of the glasses were measured depending on the temperature with calculations made on the said changes.

In another analysis made on the inventive thermochromic glass materials, the glass surfaces were made conductive with silver dye, and their electrical conductivity was measured depending on the temperature. The analyses which were performed have shown that the conductivity values of the inventive telluride glasses increase with the increased temperature, their conductivity changes reversibly with temperature, and they have semi-conductive feature. The thermochromic property shown by the telluride glasses is originated from their semi-conductive behavior.

As a result of the analyses which were made, the material comprising TeO₂—WO₃—A₂O (A: Li, Na, K) has given the best result in terms of transmittance, absorption edge, conductivity change, thermochromic property and reversible thermochromic behavior depending on temperature.

The inventive telluride glasses showing thermochromic property can be used in permeable filters used in optical and spectroscopic analysis devices and color measurement devices, calibration apparatuses, microelectronic applications, temperature sensors and data storage devices.

1.-11. (canceled)

12. A thermochromic glass material comprising at least one of heavy metal oxide, alkali oxide, halide components together with tellurium oxide (TeO₂) in order to achieve glass formation; and TeO₂ which is in ratio of 30-95% by mole and which enables transmittance value, absorption edge value and band gap energy and thus the color to continuously and reversibly change in the visible region depending on temperature, and allows electronic passage by behaving like an electrolyte as a result of being vitrified and shows semi-conductive feature.

13. A thermochromic glass material according to claim 12, wherein the material comprises at least one of WO₃, Li₂O, Na₂O, K₂O, ZnO, CdO, B₂O₃, TiO₂, CuO, Fe₂O₃, V₂O₅, PbO, Nb₂O₅, MoO₃, GeO₂, P₂O₅, Ag₂O, Sb₂O₃, PbF₂, LiCl, ZnCl₂ compounds as well as TeO_{2.}

14. A thermochromic glass material according to claim 13, wherein the material comprises 0-35% WO₃, 0-45% Li₂O, 0-40% Na₂O, 0-30% K₂O, 0-40% ZnO, 0-15% CdO, 0-27.5% B₂O₃, 0-15% TiO₂, 0-50% CuO, 0-20% Fe₂O₃, 0-55% V₂O₅, 0-20% PbO, 0-25% Nb₂O₅, 0-55% MoO₃, 0-30% GeO₂, 0-25% P₂O₅, 0-20% Ag₂O, 0-20% Sb₂O₃, 0-25% PbF₂, 0-30% LiCl, 0-30% ZnCl₂ by mole as well as TeO₂ in ratio of 30-95%.

15. A thermochromic glass material according to claim 14, wherein the material comprises 50% TeO₂, 25% WO₃, 25% Li₂O by mole.

16. A thermochromic glass production method (100) which is conducted to obtain a thermochromic glass material according to claim 12, comprising:
preparing powder mixture including at least one of heavy metal oxide, alkali oxide, halide together with TeO₂ (101),
melting the mixture by heating (102),
cooling the molten mixture by pouring into the mold and obtaining glass (103),
keeping the glass removed from the mold in the drying oven and cooling it (104).

17. A thermochromic glass production method (100) according to claim 16, further comprising preparing powder mixture (101) wherein carbonates and hydrates of Li₂O, Na₂O, K₂O, B₂O₃ oxides such as Li₂CO₃, Na₂CO₃, K₂CO₃, H₃BO₃ are used instead of the said oxides.

18. A thermochromic glass production method (100) according to claim 17, further comprising preparing powder mixture (101) wherein the compounds forming the composition are weighed and mixed homogenously.

19. A thermochromic glass production method (100) according to claim 18, further comprising melting the mixture by heating (102) wherein the mixture is placed into a furnace preheated to 750-900° C. within a crucible with lid manufactured from platinum or gold and kept for 30-60 minutes in this temperature range.

20. A thermochromic glass production method (100) according to claim 19, further comprising cooling the molten mixture by pouring into the stainless steel or bronze mold preheated to 200-250° C. in order to prevent it from suddenly cooling and cracking, and obtaining glass (103).

21. A thermochromic glass production method (100) according to claim 20, further comprising keeping the glass removed from the drying oven and cooling (104) wherein the molded glass material is kept for 60-120 minutes in a drying oven heated to 200-300° C. and then cooled to room temperature in a controlled way, therefore the internal stresses are eliminated.
